(19) United States
(12) Patent Application Publication
(10) Pub. No.: US 2023/0221342 A1
(43) Pub. Date: Jul. 13, 2023

(54) Method and Apparatus for Scanning Microscope Slides Using At Least Two Microscope Slide Scanners

(71) Applicants: Thomas Gebing, Vreden (DE); Jürgen Deuster, Peißenberg (DE); Thomas Deuster, Sachsenheim (DE)

(72) Inventors: Thomas Gebing, Vreden (DE); Jürgen Deuster, Peißenberg (DE); Thomas Deuster, Sachsenheim (DE)

(21) Appl. No.: 18/009,368

(22) PCT Filed: Jun. 15, 2021
(86) PCT No.: PCT/DE2021/100510

§ 371 Date: Dec. 9, 2022

(30) Foreign Application Priority Data
Jun. 18, 2020 (DE) 10 2020 116 138.7

(51) Int. Cl. G01N 35/00; G02B 21/34; G02B 21/26

(52) U.S. Cl. CPC G01N 35/0099; G02B 21/34; G02B 21/26; G01N 35/00029; G01N 2035/00128; G02B 2207/123

(57) ABSTRACT

A method for scanning object carriers using at least two microscope slide scanners includes a) loading a feed unit for microscope slides with a plurality of microscope slides, each of which is part of one of a plurality of sample series, b) transferring one microscope slide from the feed unit to every microscope slide scanner not loaded with a microscope slide, c) carrying out a scanning process for each loaded microscope slide scanner, d) transferring each scanned microscope slide from the microscope slide scanner to an intermediate storage rack, e) providing a data set for every scanning process for analysis, and f) transferring all microscope slides of a sample series from the intermediate storage rack to a final storage rack.

The present invention relates to a method and a device for scanning microscope slides using at least two microscope slide scanners.

Microscope slides with cell or tissue samples must be investigated in many fields, particularly in the field of pathology. To this end, the microscope slide loaded with the samples can be placed under a microscope and examined by a pathologist. For some time, it has been possible to replace classic microscopes with microscope slide scanners, which scan the microscope slide, store the recorded data and make the same available to the pathologist as a digital image on a screen.

Microscope slide scanners are known, which have loading devices, which can be loaded with a multiplicity of individual microscope slides to be scanned. Likewise, microscope slide scanners are known, which have magazines which are specially designed for the respective scanner and can be loaded with microscope slides. Thus, the microscope slide scanner can scan the individual microscope slides successively without the microscope slides having to be placed into the microscope slide scanner individually prior to each scanning process.

Disadvantages of these known microscope slide scanners are that the loading devices or magazines have to be filled with microscope slides by hand, in that the microscope slides have to be removed from the microscope slide holders, in which they are generally stored, individually and pushed into the loading device or the magazine, and that the microscope slide scanners have to be loaded with the magazines, which contain the microscope slides, by hand or these magazines have to be removed by hand. After the scanning process, the microscope slides must be removed from the loading device or the magazine again by hand and can be archived.

Often, a plurality of such microscope slide scanners are used, which have to loaded with the microscope slides separately from one another.

Generally, a multiplicity of cell or tissue samples are taken for each patient, which are placed individually on separate microscope slides and examined separately. Such a multiplicity of microscope slides with cell or tissue samples of an individual patient therefore constitutes what is known as a sample series. A sample series therefore comprises all microscope slides which are loaded with samples of one patient or samples that are otherwise related to one another.

It is currently conventional to scan all microscope slides of a sample series successively in a microscope slide scanner, in order to keep the individual microscope slides of a series together in such a manner that they can be taken out of the microscope slide scanner without further sorting and archived together.

Common archiving is advantageous, as all samples of a series are to be found at one location in the archive in this case. This also has the advantage that in the event that individual or all microscope slides of a series have to be removed from the archive for examination once again, only one placeholder is necessary in the archive, instead of the many placeholders which would be necessary if the individual samples of a series had have been archived separately in the archive.

Another disadvantage of the methods according to the prior art is that if a microscope slide scanner, which had been loaded with the samples of a series, breaks down, no further sample of this series is scanned and can be examined until the microscope slide scanner is repaired or a different microscope slide scanner is loaded with the samples of this series by hand.

It is regularly the case that the scans of the microscope slides are defective or inadequate. This may for example be because an incorrect scanning area was captured or the autofocussing was defective or unsuitable. This is usually first determined by the pathologist who examines the scans. it is therefore disadvantageous that in such a case, the corresponding microscope slide has to be removed from the archive again and re-scanned, wherein the scanning area and the focal plane are to be determined at the microscope slide scanner.

The object of the invention is to provide a method for scanning microscope slides, which overcomes the disadvantages known from the prior art. The object of the invention can therefore be seen inter alia in providing a method for scanning microscope slides, in which no labour-intensive loading and unloading of the microscope slide scanner is necessary and in which even in the event of the breakdown of a microscope slide scanner, a subset of a sample series is scanned, without the microscope slides having to be reloaded by hand. It may be seen as a further object of the invention that a sample series can be removed together from the device and archived, in a simple manner and without further re-sorting. In addition, it may be seen as an object of the invention to provide a method which enables re-scanning of samples, which were only inadequately scanned in the first scan pass, without great outlay. The object of the invention may also comprise providing a device which enables the carrying out of the method according to the invention.

To achieve the object, a method for scanning microscope slides using at least two microscope slide scanners is provided, comprising the steps
a) loading a supply unit for microscope slides with a multiplicity of microscope slides, which in each case belong to one of a plurality of sample series,
b) transferring one microscope slide in each case from the supply unit to each microscope slide scanner not loaded with a microscope slide
c) carrying out a scanning process for each loaded microscope slide scanner,
d) transferring each scanned microscope slide from the respective microscope slide scanner to an intermediate storage rack
e) providing a data record for each scanning process for examination,
f) transferring all microscope slides of a sample series from the intermediate storage rack to a final storage rack.

In this method, a supply unit is therefore provided, in which the microscope slides with the samples to be scanned are stored centrally until the scanning process, independently of which of the microscope slide scanners will execute the scanning process. The individual microscope slide scanners are therefore not manually loaded in advance with a multiplicity of microscope slides, which are scanned successively. Rather, the microscope slide scanners are automatically loaded individually from the at least one central supply unit with the microscope slides to be scanned in each case. As soon as one of the microscope slide scanners has completed the scanning process, the microscope slide is removed and placed into the intermediate storage rack. Then, a new microscope slide can be removed from the supply unit and placed into the most recently emptied microscope slide scanner. Consequently, all microscope slide scanners are regularly working at full capacity, and the microscope slides stored in the supply unit and still to be scanned are even scanned should one of the microscope slide scanners break down.

In particularly urgent cases, the order of the microscope slides to be scanned can be changed at any time by exchanging individual microscope slides in the supply unit, without the method having to be interrupted. Thus, depending on the priority of the individual samples, the scanning order can be determined or changed without interrupting the method.

According to the invention, “microscope slide” is understood to mean a substrate which contains the sample to be scanned. To this end, the sample is for the most part arranged between a glass plate substrate and a cover slip or a transparent film. The microscope slide can also comprise a code, which makes it possible to infer the sample and/or the sample series. Preferably, each microscope slide comprises an individual code, preferably in the form of a machine-readable code.

According to the invention, “scanning a microscope slide” is understood to mean scanning the sample arranged on the substrate.

In the simplest embodiment, the supply unit is a holding fixture for a multiplicity of microscope slides. Preferably, a supply unit is provided, which can be loaded with microscope slide holders, in which the microscope slides are located. In such a case, the supply unit is designed to accommodate microscope slide holders. Preferably, the supply unit is designed such that microscope slide holders of different manufacturers and with a different number of slots can be accommodated arbitrarily one behind the other, wherein the microscope slides are located in the microscope slide holders. In an advantageous embodiment, the supply unit has at least one base plate and at least one end wall. It is likewise provided according to the invention that the device comprises two or more supply units, so that different supply units can be used for different types of microscope slide holders.

Preferably, the supply unit, particularly the base plate, is arranged in a sloping manner such that a microscope slide holder placed onto the base plate slides due to gravity towards the end wall of the supply unit or towards a microscope slide holder already present in the supply unit. The base plate of the supply unit therefore forms a sloping plane. In this manner, it is ensured that in the case of a supply unit loaded with microscope slide holders, a microscope slide holder always rests against the end wall.

In an advantageous embodiment, the supply unit has the shape of a U profile, in which at least one end is closed with an end wall. The U profile is preferably arranged such that the microscope slide holders can be inserted into the profile from above. Preferably, one end with an end wall is arranged deeper than the other end, so that the base plate of the supply unit constitutes an inclined plane.

A microscope slide holder is a holder, in which a plurality of microscope slides can be arranged substantially parallel to one another. The microscope slide holders preferably have slots for 3 to 50 microscope slides in each case. The microscope slides are preferably arranged in the slots in such a manner that one narrow side of the slide faces upwards and the other narrow side faces downwards. The microscope slides can be pulled out of the microscope slide holder at the upper narrow side.

Preferably, the step of transferring a microscope slide from the supply unit to a microscope slide scanner comprises a shaking step, in which the microscope slide, which is for example gripped by an industrial robot, is shaken before and/or during the removal from the microscope slide holder. Carrying out such a shaking movement makes it possible for microscope slides jammed in the microscope slide holder and/or stuck in the microscope slide holder due to adhesive residues from the covering process to be removed without damage.

The microscope slide holder and the supply unit are preferably designed such that the supply unit can only be loaded with microscope slide holders which are arranged in the provided orientation. This means that microscope slide holders can only be loaded into the supply unit if they are orientated such that a provided side of each microscope slide holder faces the end wall of the supply unit. This can be achieved in that one side of the microscope slide holder has an elevation or lug, which can be brought into engagement with a corresponding protrusion or recess in the loading region of the supply unit.

Therefore, the two outwardly directed sides of the microscope slide holder, which are arranged in the supply unit parallel to the two side surfaces of the U profile, differ from one another. Likewise, in such an embodiment, the two side surfaces of the U profile of the supply unit differ from one another. Generally, the individual microscope slides are manually or automatically pushed into a microscope slide holder after the dyeing of the samples and the covering process, so that all microscope slides of a microscope slide holder are orientated the same way. Due to the fixed orientation of the microscope slide holders inside the supply unit, it is ensured that all microscope slides in the supply unit are orientated the same way, so that it is not necessary to check how the microscope slide to be scanned is orientated. Which side of the microscope slide holder is the provided side can therefore be determined individually and depending on the carrying out of the dyeing and covering process.

Preferably, the supply unit has a hold-down device, which is arranged such that the first microscope slide holder arranged on the end wall of the supply unit cannot be removed from the supply unit upwards. Thus, it is possible to prevent a not yet completely emptied microscope slide holder from inadvertently being lifted during the removal of a microscope slide, as a result of which microscope slides which have not yet been scanned could fall out and break.

The hold-down device is preferably a lug or protrusion arranged on the supply unit. To remove the microscope slide holder, the same is first to be moved from the end wall and thus the hold-down device in the direction of the other end of the supply unit, in order to then be able to be removed from the supply unit upwards.

A microscope slide is preferably removed from the first microscope slide holder resting against the end wall by an industrial robot. As, under certain circumstances, not all slots of the microscope slide holder are populated with microscope slides, the industrial robot can grip the individual, possibly empty, slots successively until it reaches an occupied slot, the microscope slide of which it can remove. In this manner, it is ensured that the microscope slides make it into one of the microscope slide scanners in the order in which they are located in the microscope slide holder and that each microscope slide is scanned.

According to the invention, it is therefore provided to load the supply unit with a multiplicity of microscope slides which belong to a multiplicity of series. Therefore, microscope slides of a plurality of sample series are loaded into the supply unit. A sample series comprises two or more microscope slides which in each case contain samples of one patient or samples that are otherwise related to one another. Two or more such sample series are therefore arranged in the supply unit.

The microscope slides arranged in the supply unit are removed from the supply unit, preferably in the order present, and inserted into one of the unoccupied microscope slide scanners, which carries out the scanning process.

The method according to the invention provides the use of at least two microscope slide scanners. Therefore, according to the invention, at least 2, but depending on the number of microscope slides to be scanned also 3, 4, 5, 6, 7, 8, 9, 10 or more microscope slide scanners are used. It is possible according to the invention to use cost-effective and less fault-prone standalone microscope slide scanners which do not have any loading devices or magazines for storing microscope slides.

Preferably, the individual code of each microscope slide, which is transferred into a microscope slide scanner, is detected and stored in a database. Likewise, the information about which microscope slide scanner the microscope slide was scanned by can be stored.

It is therefore likewise provided that the method according to the invention comprises one or more steps in which the microscope slide code is scanned. Likewise, it is provided that after the detection of the code, the information about where the microscope slide is located is stored. Preferably stored are the microscope slide scanner into which a microscope slide is inserted, the position at which the microscope slide is placed in the intermediate storage rack and/or the position at which the microscope slide is placed in the final storage rack. Preferably, to this end, the microscope slides, particularly the codes thereof, are detected by a separate scanner prior to the placement into a microscope slide scanner, into the intermediate storage rack and/or into the final storage rack, so that the location or the current position of each microscope slide can be read at any time.

Preferably, for each microscope slide, step b) also comprises the scanning of the microscope slide code of the said microscope slide. Preferably, in this process, not only is the code of the microscope slide read, but rather the region on a microscope slide is also identified, in which the sample to be scanned, for example the tissue, is located. According to the invention, it is likewise preferably provided that only this region of a microscope slide, in which the sample to be scanned is arranged, is scanned in one of the microscope slide scanners.

In addition, the method can comprise the creation and storage of an overview image of the complete slide, preferably by means of an overview scanner comprising at least one lighting unit and a camera.

After transferring a microscope slide into a microscope slide scanner and after completing the scanning process, the scanned microscope slide is removed from the scanner and placed in the intermediate storage rack.

The intermediate storage rack is therefore a device, in which the microscope slides are placed after the scanning process. Preferably, the microscope slides are placed in the intermediate storage rack in the order in which they are removed from the scanners and therefore in the order in which they reach the intermediate storage rack, independently of whether the microscope slides were arranged in the supply unit in a different order. The intermediate storage rack preferably comprises a multiplicity of slots or holders, into which one scanned slide can be pushed in each case. There may be embodiments with 100, 1000 or more slots or holders in the intermediate storage rack. The intermediate storage rack may therefore have any desired number of slots or holders.

Prior to the placement of the microscope slide in the intermediate storage rack, the individual code of the microscope slide can be detected. This may take place by means of a plurality of data acquisition devices, for example in the form of scanners. Preferably, the intermediate storage rack comprises a multiplicity of storage positions, wherein each storage position, that is to say each slot or holder, can accommodate one microscope slide. Each storage position can be identified by means of an individual identifier or code. Preferably, the storage position of every microscope slide placed here is stored in a database.

Preferably, all available microscope slide scanners are loaded according to step b). Preferably, all available loaded microscope slide scanners carry out a scanning process according to step c). Preferably, all available loaded microscope slide scanners are unloaded according to step d). In this manner, all microscope slide scanners of the device according to the invention of the method are used and contribute to accelerating the scanning method.

A data record for examination is provided for each scanning process by one of the microscope slide scanners. Among other things, the data record encodes the image recorded by the microscope slide scanner, which image can be examined after provision. Preferably, an examination of this type is carried out by a pathologist.

After completion of the examination of a sample series, all microscope slides of this series are transferred from the intermediate storage rack to the final storage rack. Preferably, for this, all microscope slides of a sample series are transferred individually from the intermediate storage rack to the final storage rack. Preferably, the microscope slides of a sample series are placed in the final storage rack successively. Preferably, each sample series is placed in the final storage rack in a numerically sorted manner, so that all microscope slides of a series are arranged numerically consecutively in the final storage rack.

The information that the examination of a sample series is completed can be transmitted to the device according to the invention. An examination of a sample series can likewise be considered as completed if all samples of this series have been examined without re-scanning of one or more microscope slides of this series having been requested.

Step f) can be carried out for all sample series to which the microscope slides, with which the supply unit was loaded according to step a), belong.

The final storage rack is a storage device, in which all of the microscope slides of a sample series arranged in the intermediate storage rack can be placed when the examination of the sample series is complete. The final storage rack may consist of a plurality of final storage racks or partial final storage racks. Such a multi-part final storage rack allows the exchange of a filled partial final storage rack with a new, empty partial final storage rack during the ongoing method, as a different partial final storage rack is available for placing the scanned microscope slides during the exchange process. Preferably, one sample series or a multiplicity of sample series is placed in such a partial final storage rack. All of the microscope slides of a series arranged in the final storage rack can be removed and archived together or the partial final storage racks, which comprise one or more complete sample series, can be removed and archived. A multi-part final storage rack is also advantageous if for example, sample series for third parties are scanned by means of the device, wherein these sample series have to be archived separately. In such a case, these sample series scanned for third parties can be placed in a separate partial final storage rack separately from the other sample series.

Preferably, the final storage rack has a multiplicity of identifiable partial final storage racks. Preferably, the final storage rack or each partial final storage rack has a multiplicity of final storage positions for one microscope slide in each case, wherein each final storage position can be identifiable by means of an individual identifier. Preferably, the storage position in the final storage rack for every microscope slide placed here is stored in a database.

As soon as the final storage rack or one of the partial final storage racks is completely full, information or a warning relating to this can be issued, so that the final storage rack/partial final storage rack can be emptied or changed.

Preferably, a microscope slide is removed from the supply unit as soon as a free microscope slide scanner is available. Thus, all microscope slides are removed from the supply unit successively, scanned and placed in the intermediate storage rack. Thus, each microscope slide of the supply unit is transferred to a microscope slide scanner, scanned there and subsequently transferred to the intermediate storage rack, according to the steps b), c) and d).

As explained previously, the microscope slides can be arranged in the supply unit in microscope slide holders. In advantageous embodiment of the invention, the supply unit is loaded with microscope slides arranged in microscope slide holders and the method additionally comprises the steps

a [symbol] ) Removing the microscope slide holder from the supply unit and

a [symbol] ) Placing the microscope slide holder, preferably in a microscope slide holder storage device,

wherein the steps a [symbol] ) and a [symbol] ) are preferably executed by at least one industrial robot. The steps a [symbol] ) and a [symbol] ) are preferably executed after step a) when all microscope slides of a microscope slide holder have been removed. The now empty microscope slide holder can therefore be removed from the supply unit and the microscope slides of a further microscope slide holder arranged in the supply unit can be removed for scanning. After the removal of the completely emptied microscope slide holder, the subsequent microscope slide holders can automatically slide in the direction of the end wall. Due to the automatic removal of the emptied microscope slide holders, space is created in the supply unit for the loading of the supply unit with further microscope slide holders.

After the scanning of the microscope slides by the microscope slide scanners and prior to the placement of the microscope slides in the intermediate storage rack, a check is preferably carried out as to whether the microscope slides are damaged. Thus, it can be ensured that it is detected, if part of a microscope slide part that has broken off during the loading or unloading process has remained in one of the microscope slide scanners. Preferably, the length of the microscope slide is checked to this end. Preferably, the length check is carried out mechanically. Particularly preferably, the microscope slide is guided past a switch, particularly a microswitch, to check the length in such a manner that this switch is only triggered if the microscope slide has the original length. For the case that it is detected that the microscope slide is damaged, it is provided that the microscope slide scanner in which the defective microscope slide was scanned is no longer loaded with a new microscope slide, but rather is counted as “blocked” and a corresponding warning is output. The non-blocked microscope slide scanners continue to be available however, so that the method according to the invention can be carried out further.

In an advantageous embodiment of the invention, it is provided that the microscope slides that cannot be scanned by the microscope slide scanners and/or for which the microscope slide code cannot be read and/or which were detected as damaged, are not placed in the intermediate storage rack, but rather in a separate collecting device for defective microscope slides.

In an advantageous embodiment of the invention, the placement of the microscope slides in the intermediate storage rack according to step d) takes place in an unordered manner according to sample series. In such an embodiment, a microscope slide is placed in the intermediate storage rack arbitrarily. Preferably, a microscope slide is therefore pushed into a free slot of the intermediate storage rack independently of whether the adjacent slots are free or are occupied with microscope slides of other sample series. Thus, the order of the microscope slides, in which they are arranged in the intermediate storage rack may differ from the order of the microscope slides, in which they are arranged in the supply unit.

In an advantageous embodiment of the invention, in step f), the stored storage position in the intermediate storage rack is read for all microscope slides of the respective sample series and the microscope slides are ordered in the final storage rack according to sample series. In this case, all microscope slides of a sample series are arranged directly consecutively in the final storage rack.

During a scan of a microscope slide, the focal plane of is generally determined automatically by the software of the microscope slide scanner. As the samples arranged on the microscope slides may have a surface topography, for example in the form of structuring, it is regularly the case that the software-side predetermined focal plane is not chosen optimally. In addition, it may be the case that certain sample regions, which are important for the examination, are not scanned. However, that the scan was only carried out inadequately is for the most part only determined during the examination, for example during consideration of the recorded image by the pathologist, at a time when the microscope slides—if using a device according to the prior art—have already been removed from the device and archived.

In an advantageous embodiment of the invention, after step e) and before step f), the method additionally comprises the steps

e [symbol] ) transferring a microscope slide from the intermediate storage rack to an unloaded microscope slide scanner,

e [symbol] ) carrying out a re-scanning process of the microscope slide,

e [symbol] ) transferring the re-scanned microscope slide to the intermediate storage rack.

The additional steps e [symbol] ) to e [symbol] ) ensure that an inadequately scanned microscope slide can be scanned again before placement in the final storage rack. Preferably, it is determined directly after the provision of the data record, particularly during the examination by a pathologist, whether the microscope slide to be examined is to be re-scanned. For the case that a scan of a microscope slide is inadequate, this information can be transmitted to the device according to the invention, so that the corresponding microscope slide is subsequently removed from the intermediate storage rack again and transferred to an unoccupied microscope slide scanner. After carrying out the re-scan, the microscope slide is again transferred to the intermediate storage rack.

The examination is preferably carried out on a computer with monitor, on which examination software is installed. The computer can be connected to the device according to the invention for scanning the microscope slides according to the method according to the invention and can transmit the input information or control commands to the device.

In an advantageous embodiment of the invention, after step e), the scanning parameters for the scanning process according to step e [symbol] ) are determined. Thus, it is possible that it is possible to determine during the examination on the displayed scan of the microscope slide, which focal plane is to be used in the re-scan according to step e [symbol] ). To this end, a focal plane can preferably be defined in the displayed image in that three points are set, which determine the focal plane. Likewise it is possible to determine which region of the microscope slide is to be scanned. This information can be transmitted to the device according to the invention, so that the corresponding microscope slide can be removed from the intermediate storage rack and the microscope slide scanner carrying out the scan can focus this plane or this scanning area.

Therefore, it is preferably determined after step e) for each data record, whether the associated microscope slide is to be re-scanned according to the steps e [symbol] ) to e [symbol] ). The steps e [symbol] ) to e [symbol] ) can be carried out for one, for a plurality or for all of the microscope slides located in the intermediate storage rack.

In an advantageous embodiment, step e [symbol] ) is executed for a microscope slide to be re-scanned, prior to step b), in which a different microscope slide is transferred from the supply unit to one of the microscope slide scanners. In this manner, a new data record of a re-scan can be provided for examination swiftly.

In an advantageous embodiment of the invention, at least one microscope slide scanner differs from the remaining available microscope slide scanner(s). In particular, scanners with different objective lenses, which differ with regards to magnification for example, are used. Preferably, at least one microscope slide scanner is present, which has an objective lens with a higher magnification than the majority of the remaining microscope slide scanners. In this manner, it is possible to ensure that each microscope slide can be scanned with the suitable microscope slide scanner. This is important in particular, if for example, a re-scanning process of a microscope slide is to be carried out according to step e [symbol] ), for example if a specific region of the microscope slide is to be scanned in a more detailed manner. In this case, the microscope slide scanner which has the optimum magnification level can be selected.

In advantageous embodiment of the invention, at least one of the steps b), d), f), e [symbol] ) and e [symbol] ) is executed by at least one industrial robot. Preferably, a plurality of these steps is executed by at least one industrial robot. Preferably, the steps b), d), f) and—if present in the method—likewise the steps e [symbol] ) and e [symbol] ) are executed by at least one industrial robot. Particularly preferably, one, a plurality or all of the steps b), d), f), e [symbol] ) and e [symbol] ) are carried out by one single industrial robot.

“At least one industrial robot” is understood to mean one or more programmable machines, which can execute the method steps provided for the industrial robot alone or together. If only one single industrial robot is used, this is designed such that it can execute all method steps, for the execution of which the use of the industrial robot is provided. The industrial robot preferably comprises a robotic arm, a control device and a gripper.

In an advantageous embodiment of the invention, the at least one industrial robot is an articulated robotic arm. Preferably, the at least one industrial robot is a 6-axis, 7-axis or 8-axis articulated robotic arm. The articulated robotic arm preferably comprises a gripper for gripping the microscope slides. Preferably, the same articulated robotic arm which removed the microscope slide from the supply unit also inserts the microscope slide into a microscope slide scanner, removes the same from the microscope slide scanner and transfers the same to the intermediate storage rack and to the final storage rack.

The microscope slide scanners are preferably arranged such that the industrial robot can load and unload each microscope slide scanner. The microscope slide scanners can be arranged in one plane. It is likewise possible, particularly in the case of the use of a 7- or 8-axis articulated robotic arm, that the microscope slide scanners are arranged both next to and above one another, so that a wall of microscope slide scanners is formed. A plurality of walls of microscope slide scanners may also be arranged around the industrial robot.

The method according to the invention at least comprises the steps a) to f). The method according to the invention may therefore comprise further method steps. In an advantageous embodiment of the invention, step b) is repeated before the execution of the step d) until every microscope slide scanner is occupied with a microscope slide.

Preferably, the method steps b) to f) are repeated until all microscope slides are removed from the supply unit and/or until the intermediate storage rack is completely emptied.

In addition, it is provided according to the invention that the method step a) is executed anew at the same time as one of the method steps b) to f). The method according to the invention therefore provides the further loading of the supply unit with microscope slides during the ongoing method.

In an advantageous embodiment, the method consists of the steps a) to f), and optionally also of the steps e [symbol] ) to e [symbol] ) and/or a [symbol] ), a [symbol] ), wherein each step can be executed multiple times.

In an advantageous embodiment of the invention, information can be transmitted between the individual components of the device according to the invention, such as for example the microscope slide scanners and the at least one industrial robot, or between the individual components and a central control device, so that the individual method steps can be temporally coordinated. For example, after completing a scanning process, a microscope slide scanner can output an information signal with the information that the scanning process is completed. This signal can be converted into a control signal for the industrial robot, which causes the same to remove the corresponding microscope slide from the microscope slide scanner and place it into a free slot of the intermediate storage rack or transfer it from the intermediate storage rack to the final storage rack. The control device can likewise be formed as a constituent of the industrial robot itself.

In an advantageous embodiment of the invention, following the removal of a microscope slide from one of the microscope slide scanners and the placement of the microscope slide into the intermediate storage rack, an industrial robot immediately removes a microscope slide from the supply unit and places this microscope slide into the unloaded or the most recently emptied microscope slide scanner, independently of whether a different microscope slide scanner has in the meantime transmitted the information that the scanning process is completed. In this manner, the downtime of the microscope slide scanners is shortened.

In an advantageous embodiment of the invention, the microscope slide scanners can have a rotatable receptacle for microscope slides. Particularly preferably, the receptacle is constructed as a rotary plate, which rotates by 90° about a vertical axis for loading. Many microscope slide scanners according to the prior art have a receptacle for microscope slides, in which the microscope slides are to be inserted from the side as viewed from the frontal view of the microscope slide scanner. In order to facilitate the insertion of the microscope slides by the industrial robot, the microscope slide receptacle is rotated for loading such that the microscope slides are to be inserted into the receptacle frontally.

The object of the invention is additionally to provide a device for scanning microscope slides according to the method according to the invention, which overcomes the disadvantages known from the prior art.

To achieve the object, a device for scanning microscope slides according to the method according to the invention is provided, comprising

A) at least one supply unit for microscope slides,

B) at least two microscope slide scanners,

C) at least one intermediate storage rack for microscope slides, and

D) at least one final storage rack for microscope slides.

In an advantageous embodiment of the invention, the device comprises at least one industrial robot, which is designed to execute one, a plurality or all of the steps b), d) and f) and/or is designed to execute the steps e [symbol] ) and e [symbol] ). Preferably, the device comprises a single industrial robot, which is designed to execute all of the steps b), d) and f) and/or the steps e [symbol] ) and e [symbol] ). Preferably, the device therefore comprises only one single industrial robot, preferably a single articulated robotic arm, for transporting the microscope slides from the supply unit to a microscope slide scanner, from a microscope slide scanner to the intermediate storage rack, from the intermediate storage rack to the final storage rack, and optionally from the intermediate storage rack to a microscope slide scanner.

The device according to the invention is designed to carry out the method according to the invention. Thus, the device makes it possible that the method can be carried out independently, continuously and without manual intervention, wherein data records are provided for examination.

The device constituents A) to D) are preferably arranged on a base frame, so that a compact device is provided, which is so mobile that it can for example be transported through door openings without disassembly. The base frame is preferably provided with a casing, which surrounds the supply unit, the storage racks and the microscope slide scanners. In addition, a control panel and/or control elements for operating the device can be provided.

The description of the device according to the invention and the method according to the invention are provided as complementary to one another, so that method details, which are explained in connection with the device, are likewise to be understood as method details individually or in combination. Features of the invention, which are explained in connection with the method according to the invention, are also to be understood as features of the device according to the invention individually or in combination with one another.

The invention is explained once again in the following on the basis of the figures.

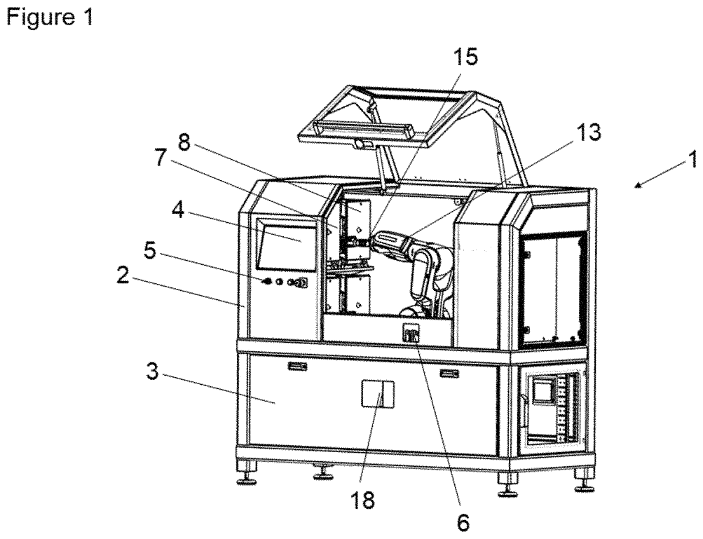

FIG. 1 shows an exemplary embodiment of a device according to the invention in a schematic illustration.

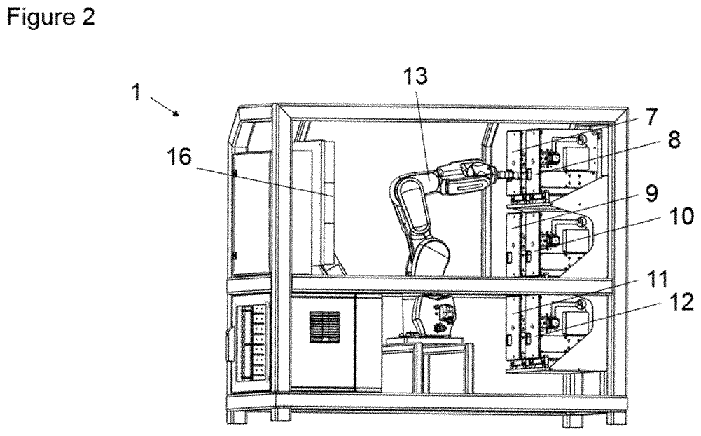

FIG. 2 shows an exemplary embodiment of a device according to the invention in a schematic illustration.

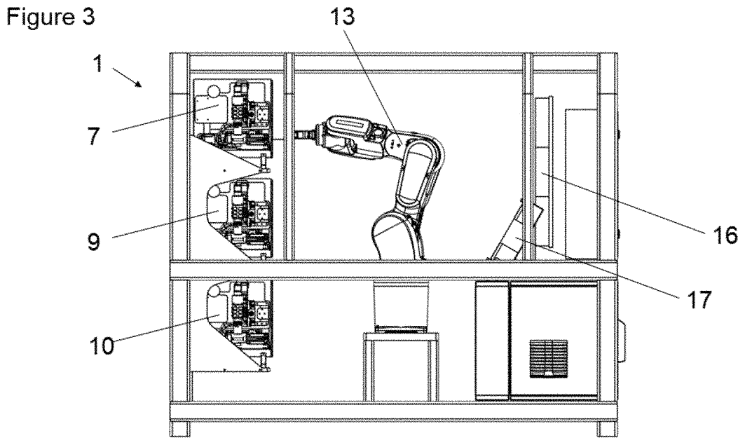

FIG. 3 shows an exemplary embodiment of a device according to the invention in a schematic illustration.

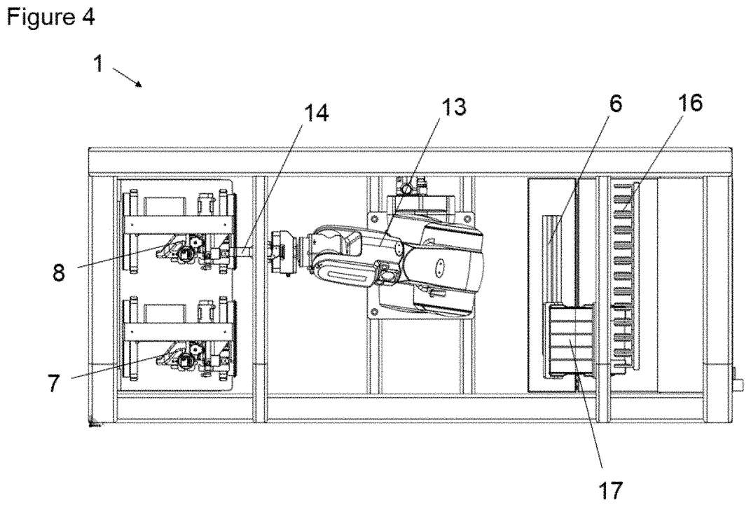

FIG. 4 shows an exemplary embodiment of a device according to the invention in a schematic illustration.

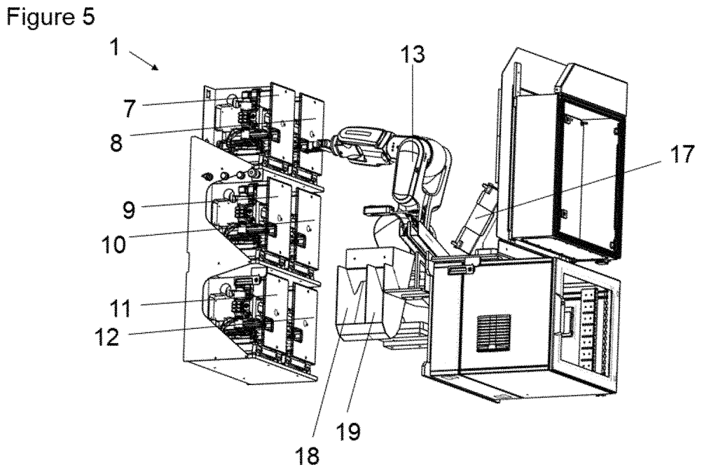

FIG. 5 shows an exemplary embodiment of a device according to the invention in a schematic illustration.

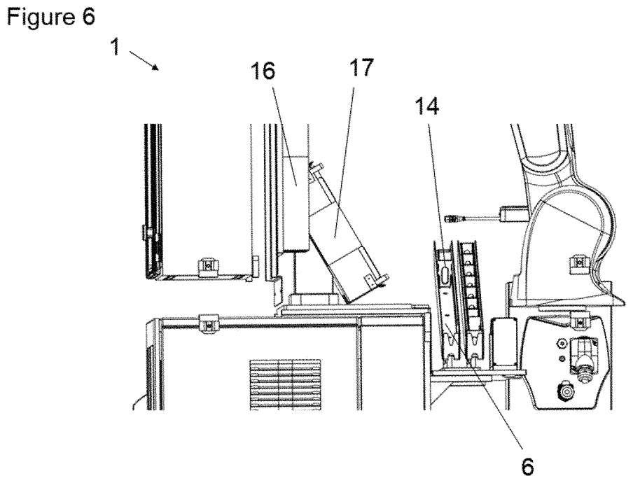

FIG. 6 shows a detail of an exemplary embodiment of a device according to the invention in a schematic illustration.

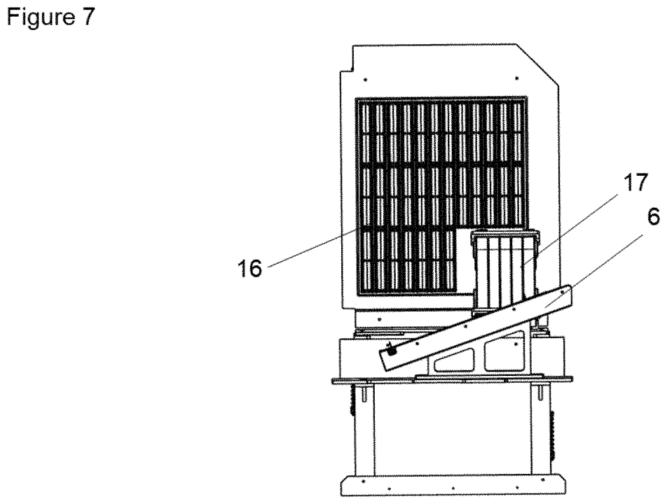

FIG. 7 shows a detail of an exemplary embodiment of a device according to the invention in a schematic illustration.

FIG. 1 shows a device 1 for scanning microscope slides in perspective view comprising a base frame 2, on which a supply unit 6 and a plurality of microscope slide scanners 7, 8, and an industrial robot 13 in the form of an articulated robotic arm are arranged. The device is provided with a casing 3, which is mounted on the base frame 2. The device can be operated by means of a control panel 4 and with the aid of control elements 5. The device has a flap, shown here in the open state, which can be closed, so that the working area of the industrial robot 13 is not accessible from outside. The supply unit 6 can be loaded from outside with microscope slide holders, which are loaded with microscope slides, through an opening of the casing in the region of the supply unit 6. The articulated robotic arm 13 can transfer the microscope slides arranged in the supply unit by means of a gripper 15 into the microscope slide scanners 7, 8 and the further microscope slide scanners not provided with reference numbers here. As soon as all microscope slides of a microscope slide holder arranged in the supply unit 6 have been transferred to a microscope slide scanner, the articulated robotic arm 13 transfers the empty microscope slide holder, with the aid of the gripper 15, to the microscope slide holder storage rack 18, which is accessible from outside through an opening in the casing 3.

FIG. 2 shows a device 1 according to the invention in perspective view, comprising six microscope slide scanners 7, 8, 9, 10, 11, 12 mounted on a side wall of the base frame. An intermediate storage rack 16 for intermediate storage of the microscope slides is provided on the opposite side wall, in which intermediate storage rack the microscope slides can be stored temporarily after carrying out a scan in one of the six microscope slide scanners 7, 8, 9, 10, 11, 12, before the microscope slides are re-scanned or transferred to the final storage rack.

FIG. 3 shows a device 1 according to the invention in side view, with the microscope slide scanners 7, 9, 10, which can be loaded with microscope slides by the industrial robot 13. The scanned microscope slides can subsequently be transferred to the intermediate storage rack 16. From the intermediate storage rack 16, the microscope slides can either be re-scanned in one of the microscope slide scanners or be transferred to the final storage rack 17.

FIG. 4 shows a device 1 according to the invention from the view from above. The device 1 comprises the microscope slide scanners 7, 8. The articulated robotic arm 13 can remove microscope slides 14 from the supply unit 6 and transfer them to the microscope slide scanner 7, 8. After the scanning process, the scanned microscope slides 14 can be transferred by the articulated robotic arm 13 to the intermediate storage rack 16. From the intermediate storage rack 16, the microscope slides 14 can be transferred to the final storage rack 17. The final storage rack 17 is constructed in multiple parts, here five parts. The intermediate storage rack 16 has a multiplicity of storage positions for one microscope slide 14 in each case. In the intermediate storage rack, the microscope slides 14 can be stored in an unordered manner according to sample series. All microscope slides 14 of a sample series, which are arranged arbitrarily in a distributed manner in the intermediate storage rack 16, can be removed successively from the intermediate storage rack 16 by the articulated robotic arm 13 and arranged consecutively in the final storage rack 17. Preferably, all microscope slides 14 of a sample series can be arranged in a partial final storage rack and can be removed together and archived for example.

FIG. 5 shows a device 1 according to the invention in perspective view, in which a multiplicity of microscope slide scanners 7, 8, 9, 10, 11, 12, an industrial robot 13 and a final storage rack 17 are illustrated. A microscope slide holder storage rack 18 is also to be seen, which is designed to accommodate the empty microscope slide holders. The device additionally comprises a collecting device for defective microscope slides 19, into which the microscope slides which cannot be scanned, for which a defect was detected or the codes of which cannot be read, can be transferred.

FIG. 6 shows a detail illustration of a device 1 according to the invention, in which a supply unit 6 loaded with microscope slides 14, an intermediate storage rack 16 and a final storage rack 17 are illustrated. The supply unit 6 is designed as a two-part supply unit 6, wherein each partial supply unit 6 has a base plate arranged in a sloping manner. The supply unit 6 is designed to accommodate individual microscope slides 14 or microscope slide holders, which are loaded with microscope slides 14. Microscope slide holders, which can be given to the supply unit 6, can slide towards an end wall due to gravity.

FIG. 7 shows a partial illustration of a device according to the invention. A supply unit 6, an intermediate storage rack 16 and a final storage rack 17 are illustrated. The supply unit 6 is designed to accommodate microscope slide holders loaded with microscope slides. The intermediate storage rack 16 is designed to accommodate a multiplicity of microscope slides, wherein each storage position of the intermediate storage rack 16 has an individual identifier. The final storage rack 17 is likewise designed to accommodate a multiplicity of microscope slides. Whilst the microscope slides in the intermediate storage rack 16 are generally not arranged in an ordered manner according to sample series, the microscope slides in the final storage rack 17 are arranged according to sample series.

### REFERENCE LIST

1) Device
2) Base frame
3) Casing
4) Control panel
5) Control element
6) Supply unit
7) Microscope slide scanner
8) Microscope slide scanner
9) Microscope slide scanner
10) Microscope slide scanner
11) Microscope slide scanner
12) Microscope slide scanner
13) Industrial robot
14) Microscope slide
15) Gripper
16) Intermediate storage rack
17) Final storage rack
18) Microscope slide holder storage rack
19) Collecting device for defective microscope slides

1. A method for scanning microscope slides using at least two microscope slide scanners (7, 8, 9, 10, 11, 12), comprising:
a) loading a supply unit (6) for microscope slides (14) with a multiplicity of microscope slides (14), which in each case belong to one of a plurality of sample series,
b) transferring one microscope slide (14) in each case from the supply unit (6) to each microscope slide scanner (7, 8, 9, 10, 11, 12) not loaded with a microscope slide,
c) carrying out a scanning process for each loaded microscope slide scanner (7, 8, 9, 10, 11, 12),
d) transferring each scanned microscope slide (14) from the respective microscope slide scanner (7, 8, 9, 10, 11, 12) to an intermediate storage rack (16),
e) providing a data record for each scanning process for examination, and
f) transferring all microscope slides (14) of a sample series from the intermediate storage rack (16) to a final storage rack (17).

2. The method according to claim 1, wherein each microscope slide of the supply unit (6) is transferred to a microscope slide scanner (7, 8, 9, 10, 11, 12), scanned there and subsequently transferred to the intermediate storage rack (16), according to the steps b), c) and d).

3. The method according to claim 1, wherein step f) is carried out for all sample series to which the microscope slides (14), with which the supply unit (6) was loaded according to step a), belong.

4. The method according to claim 1, wherein the intermediate storage rack (16) has a multiplicity of identifiable storage positions and the storage position of each microscope slide (14) in the intermediate storage rack (16) is stored in a database.

5. The method according to claim 1, wherein in step d), the microscope slides (14) are placed in the intermediate storage rack (16) in an unordered manner according to sample series.

6. The method according to claim 1, wherein, in step f), the stored storage position in the intermediate storage rack (16) is read for all microscope slides (14) of the respective sample series and the microscope slides (14) are ordered in the final storage rack (17) according to sample series.

7. The method according to claim 1, wherein, after step e) and before step f), the method additionally comprises:
e [symbol] ) transferring a microscope slide (14) from the intermediate storage rack (16) to an unloaded microscope slide scanner (7, 8, 9, 10, 11, 12),
e [symbol] ) carrying out a re-scanning process of the microscope slide (14), and
e [symbol] ) transferring the re-scanned microscope slide (14) to the intermediate storage rack (16).

8. The method according to claim 7, comprising after step e) for each data record, determining whether the associated microscope slide (14) is to be re-scanned according to the steps e [symbol] ) to e [symbol] ).

9. The method according to claim 7, wherein, after step e), the scanning parameters for the scanning process according to step e [symbol] ) are determined.

10. The method according to claim 1, wherein one, a plurality or all transfers of the microscope slides (14) according to the steps b), d) and f), and/or the steps e [symbol] ) and e [symbol] ) are executed by at least one industrial robot (13).

11. The method according to claim 10, wherein the at least one industrial robot (13) is an articulated robotic arm.

12. A device (1) for scanning microscope slides (14) according to the method according to claim 1, comprising:
at least one supply unit (6) for microscope slides,
at least two microscope slide scanners (7, 8, 9, 10, 11, 12),
at least one intermediate storage rack (16) for microscope slides, and
at least one final storage rack (17) for microscope slides.

13. The device according to claim 12, comprising at least one industrial robot (13), designed to execute one, a plurality or all of the steps b), d) and f).

14. The method according to claim 1, wherein one, a plurality or all transfers of the microscope slides according to the steps b), d) and f), and/or the steps e [symbol] ) and e [symbol] ) are executed by exactly one industrial robot.

15. The method according to claim 10, wherein the at least one industrial robot is a 6-axis, 7-axis or 8-axis articulated robotic arm, which has a gripper for gripping the microscope slides.

16. The device according to claim 12, comprising exactly one industrial robot, which is designed to execute one, a plurality or all of the steps b), d) and f).
